(19) United States
(12) Patent Application Publication
(10) Pub. No.: US 2004/0259749 A1
(43) Pub. Date: Dec. 23, 2004

(54) Cleaning composition for use in a laundry or dishwashing machine

(75) Inventors: Karl Ghislain Braeckman, Chatelet (BE); Regine Labeque, Brussels (BE); Harold Emmerson, Newcastle upon Tyne (GB); Anju Deepali Massey Brooker, Newcastle upon Tyne (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/851,713

(22) Filed: May 21, 2004

(30) Foreign Application Priority Data
May 23, 2003 (EP) 03 447 11.8

(51) Int. Cl. C11D 1/00

(52) U.S. Cl. 510/220

(57) ABSTRACT

The present invention relates to a cleaning composition for use in an automatic laundry or dishwashing machine, the cleaning composition comprising at least two functional parts and at least one release controlling means comprising an amino-acetylated polysaccharide having a selected degree of acetylation.

The cleaning composition of the present invention not only allows an excellent sequential release of its different constituents, but also provides various beneficial properties, such as healthcare benefits and fabric care benefits.

### CROSS REFERENCE

This case claims priority to European Application Serial No. 03447118.5 filed May 23, 2003.

### TECHNICAL FIELD

The present invention relates to automatic washing, in particular it relates to cleaning compositions comprising a plurality of functional parts adapted to release different compositions in different cycles of the washing process.

### BACKGROUND OF THE INVENTION

Nowadays, modern washing or dishwashing machines can vary for a large extent in terms of the washing programs under which they operate, the latter may indeed significantly differ in temperature and duration of the individual basic cycles. However, it is recognized that automatic washing operations typically comprise four main cycles: a pre-washing cycle, a main washing cycle, one or several rinsing cycles, and a spinning cycle. Compositions suitable for use in automatic machines generally comprise several active compounds which, in the course of an entire wash cycle, perform their function only at certain stages.

For a long time, the consumer was provided with laundry detergents or dishwashing detergents in the form of bulk-packaged goods and it was left up to him at the time of use to dose the detergent in accordance with the requirements of the application. However, in view of the consumer's desire to have laundry or dishwashing detergents which are easier and more convenient to dose, these detergents were increasingly provided in a form which obviates the need for dosing and were then formulated in predetermined portions comprising all of the components required for one washing operation. In the case of solid products, such portions were frequently formed into shapes such as granules, beads, tablets, cubes, briquettes, etc., which are dosed as a whole into the liquor. Detergent compositions in tablet form hold additional advantages such as ease of handling, transportation and storage. Consumers particularly like the convenience of a shaped detergent composition that they can dose via the dispensing drawer.

A disadvantage of these solutions is that all of the ingredients required in the course of a wash operation pass simultaneously into the aqueous liquor, giving rise to chemical incompatibilities of certain components in the wash liquor. For instance, enzymes or perfumes might be quickly deactivated by the oxidative action of a bleach system, cationic active molecules are precipitated by anionic surfactants. It is therefore highly desirable to delay the delivery of some active agents, either later during the wash cycle, or during the rinse cycle.

EP-A-481547 discloses a dishwashing detergent tablet which, it is alleged, can provide sequential release of a dishwashing composition and a rinse aid composition. The tablets of EP-A-481547 have an inner layer which is completely surrounded on all sides by a barrier layer which, in turn, is completely surrounded by an outer layer. WO-A-00/04129 describes multi-phase detergent tablets comprising a first phase in the form of a shaped body having at least one mould therein and a second phase in the form of a particulate solid compressed within said mould. In preferred embodiments of the tablets disclosed in WO-A-00/04129, the second phase dissolves before the first phase. U.S. Pat. No. 2001/0031714 describes a multilayer tablet comprising a release controlling (physico)chemical switch which is not subject or not exclusively subject to temperature control.

However, several problems are associated with many of the prior art tablets formulated with benefit(s) agent(s). Often these tablets do not effectively control the release of the actives. Many of the benefit agents work more effectively when released in the rinse cycle. However, in the case of tablets comprising particles containing actives, it is very frequent that said particles be expelled from the wash before the rinse cycle along with the wash liquor from the main wash before having a chance to release the active(s). Even when the particles do survive until the rinse cycle, they often do not deliver the benefit uniformly through the wash.

It is an object of the present invention to provide a cleaning composition designed to efficiently delay the delivery of an active until the appropriate time in the whole washing cycle of a washing or dishwashing machine. In particular, the present invention relates to cleaning compositions containing a pH sensitive release-controlling means comprising an amino-acetylated polysaccharide with a selected degree of acetylation.

Components exhibiting pH-dependent solubility are well known in the art, in particular from pharmacy. Suitable compounds are preferably basic by nature and are in particular basic polymers. The use of high pH-sensitive soluble basic polymers has also been considered in other contexts, such as in laundry or dishwashing tablet field. Also, U.S. Pat. No. 2001/0031714 discloses a multi-layer tablet including a release-controlling (physico)chemical switch comprising a pH-dependent soluble polymer. Suitable polymeric materials undergo a change in solubility in the pH range from 8 to 10, and are preferably aminoalkyl methacrylate copolymers. CA-A-2338710 and CA-A-2304526 describe a composite tablet comprising a coated particle arranged in a cavity. Said coating is described to be pH-sensitive and is made of a polymeric carbohydrate comprising a pending basic function.

The cleaning compositions of the invention allow for flexible formulation permitting, for example, the separation of mutually-incompatible ingredients either on storage or in the wash liquor and the separation of ingredients provided in different physical forms. The compositions according to the present invention allow for sequential controlled release of different products into different cycles, and thus provide an optimised washing process.

Furthermore, designing a cleaning composition containing at least one release controlling means comprising an amino-acetylated polysaccharide having a selected degree of acetylation, not only allows an excellent sequential release of its different constituents, but also provides various beneficial care properties.

According to the present invention, a particularly preferred amino-acetylated polysaccharide is chitosan. Chitosan is a natural high molecular material made from polysaccharide chitin which is widely distributed in shells of crustacean, insect outer skins, mushrooms. Specifically, chitosan is commercially produced from chitin, or poly-N-acetyl-D-glucosamine, which has been deacetylated to provide sufficient free amino groups to render the polymer readily soluble in diluted organic acids.

Chitosan and its derivatives are known to have anti-microbial properties and to be inhibitory to a number of pathogenic fungi. For these reasons, chitosan in a high quality has been developed and widely used in various industrial field such as food, cosmetics, pharmaceuticals and absorbents, activating agent for plant cells, aggregating agent for waste water disposal, etc.

UK Patent GB-A-2363614 describes laundry and/or fabric care compositions which utilize chitosan-based polymer materials as fabric treatment agents that can impart fabric appearance and integrity benefits to fabrics and textiles laundered in washing solutions which contain such materials.

In particular, the use of chitosan has recently been described for providing benefits such as improved fabric softness benefits; fabric feel benefits; garment shape retention benefits; elasticity benefits; ease of ironing benefits; perfume benefits; anti-wrinkle benefits; colour care benefits, such as dye fixation or dye transfer inhibition; or any combination thereof.

The present invention describes the first use of amino-acetylated polysaccharides having a selected degree of acetylation, as pH-sensitive materials in the context of a cleaning composition for use in an automatic laundry or dishwashing machine.

Other objects and more specific properties of the cleaning compositions according to the present invention will be clear after reading the following description of the invention.

### SUMMARY OF THE INVENTION

According to a first embodiment of the present invention, it is provided a cleaning composition, for use in an automatic laundry or dishwashing machine, comprising at least two functional parts including a primary functional part, and a secondary functional part, wherein in use in an automatic laundry or dishwashing machine having a main-wash cycle and a rinse cycle, the primary functional part releases a primary composition into the main wash, and the secondary functional part releases a secondary composition into the rinse, the cleaning composition further comprising at least one release controlling means capable of preventing said secondary composition to be released into the main wash liquor, said means comprising an amino-acetylated polysaccharide having a selected degree of acetylation.

In a preferred embodiment, the present invention relates to a cleaning composition in the form of a tablet provided with at least one cavity formed within the primary functional part, the cavity containing the secondary functional part in the form of at least one particle, the external surface of said secondary functional part being entirely covered with a coating comprising an amino-acetylated polysaccharide with a selected degree of acetylation.

Another embodiment of the present invention relates to a process for making the cleaning compositions of the present invention, the process comprising the steps of: a) preparing the secondary functional part comprising the secondary composition, then b) coating the secondary functional part formed in step (a) with a film or coating comprising an amino-acetylated polysaccharide derivative having a degree of actetylation comprised in the range from 30% to 80%; and c) preparing the primary functional part comprising the primary composition and enclosing the coated secondary functional part formed in step (b).

According to still another embodiment, the present invention is directed to a pH sensitive film or coating composition comprising an amino-acetylated polysaccharide having a degree of acetylation comprised in the range from 30% to 80%, preferably from 45% to 75%.

### DETAILED DESCRIPTION OF THE INVENTION

Functional Parts

In a first embodiment, the present invention relates to a cleaning composition comprising at least two functional parts and at least one release controlling means, the latter comprising an amino-acetylated polysaccharide with a selected degree of acetylation.

In the context of the present invention, the expression “functional part” refers to a portion of the cleaning composition intended to perform a certain function at a certain stage of the whole washing process. The primary and secondary functional parts can be in the form of a pouch, capsule, tablet or granule. Therefore, they may adopt any suitable shape such as hexagonal, square, rectangular, cylindrical, spherical, etc. Furthermore, each functional part can be unitary or made of distinct parts such as layers.

Preferably, the primary functional part is in the form of a tablet and the secondary functional part is in the form at least one particle.

When used in an automatic laundry or dishwashing machine, the primary functional part releases a primary composition into the main wash, and the secondary functional part is intended to release a secondary composition into the rinse. The primary and secondary compositions may be provided in the form of free flowing powder, compressed powder, liquid, liquid-solid suspension, gel or paste.

Primary Composition

In accordance to the present invention, the primary composition preferably comprises compounds selected from the following non-limiting list of ingredients, and mixtures thereof.

Surfactant

Preferably, the surfactant for use in the product of the present invention, is a low foaming surfactant by itself or in combination with other components (i.e. suds suppressers). Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxy-lates derived from C₆-C₁₈ primary alcohols), ethoxylated-propoxylated alcohols (e.g., BASF Poly-Tergent® SLF18), epoxy-capped poly(oxyalkylated) alcohols (e.g., BASF Poly-Tergent® SLF18B—see WO-A-94/22800), ether-capped poly(oxyalkylated) alcohol surfactants, and block polyoxyethylene-polyoxypropylene polymeric compounds such as Pluronic®, Reversed Pluronic®, and Tetronic® by the BASF-Wyandotte Corp., Wyandotte, Mich.; amphoteric surfactants such as the C₁₂-C₂₀ alkyl amine oxides (preferred amine oxides for use herein include C₁₂ lauryldimethyl amine oxide, C₁₄ and C₁₆ hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874.

Builders

Builders suitable for use herein include water-soluble builders such as citrates, carbonates and polyphosphates e.g. sodium tripolyphosphate and sodium tripolyphosphate hexahydrate, potassium tripolyphosphate and mixed sodium and potassium tripolyphosphate salts; and partially water-soluble or insoluble builders such as crystalline layered silicates (EP-A-0164514 and EP-A-0293640) and aluminosilicates inclusive of Zeolites A, B, P, X, HS and MAP. The builder is typically present at a level of from about 1% to about 80% by weight, preferably from about 10% to about 70% by weight, most preferably from about 20% to about 60% by weight of composition. Also suitable as builders are copolymeric polycarboxylates, especially those of acrylic acid with methacrylic acid and of acrylic acid or methacrylic acid with maleic acid. Copolymers which have been found particularly suitable are those of acrylic acid with maleic acid which contain from 50 to 90% by weight of acrylic acid and from 50 to 10% by weight of maleic acid.

Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 Lipase^{R} and Lipomax^{R} (Gist-Brocades) and Lipolase^{R} and Lipolase Ultra^{R} (Novo); cutinases; proteases such as Esperase^{R}, Alcalase^{R}, Durazym^{R}, Savinase^{R} (Novo) and Maxatase^{R}, Maxacal^{R}, Properase^{R}, Maxapem^{R} (Gist-Brocades) and Protease A^{R}, Protease B^{R}, Protease C^{R}, Protease D^{R} (EP-A-1201743); α and β amylases such as Purafect Ox Am^{R} (Genencor) and Termamyl^{R}, Ban^{R}, Fungamyl^{R}, Duramyl^{R}, and Natalase^{R} (Novo); pectinases; and mixtures thereof. Enzymes are preferably added herein as prills, granulates, or cogranulates at levels typically in the range from about 0.0001% to about 2% pure enzyme by weight of composition.

Bleaching Agent

Bleaching agents suitable herein include oxygen (especially in the primary composition) and chlorine (especially in the secondary composition) bleaches. Preferred oxygen bleaches are inorganic perhydrate salts such as sodium perborate mono- and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially iron, manganese or cobalt). Other suitable bleaching agents are the so-called photobleach. Chlorine bleaching agents preferred for use herein are those which yield a hypochlorite species in aqueous solutions including alkali metal and alkaline earth metal hypochlorites, hypochlorite addition products, chloramines, chlorimines, chloramides, and chlorimides. Specific examples of compounds of this type include sodium hypochlorite, potassium hypochlorite, monobasic calcium hypochlorite, N-chlorosulfamide, Chloramine T, Dichloramine T, Chloramine B and Dichloramine B.

The primary composition can also comprise some benefits agents listed below for the secondary composition.

Secondary Composition

According to the present invention, the secondary composition comprises actives or benefit agents, those being preferably selected from the following non-limiting list of ingredients, and mixtures thereof.

Softening Agents

The cleaning composition according to the present invention may comprise softening agents. Preferably, softening agents for use herein are selected from the group of cationic softening agents. Any suitable cationic softening agents may be used herein, but preferred are quaternary ammonium agents. As used herein, the term “quaternary ammonium agent” means a compound or mixture of compounds having a quaternary nitrogen atom and having one or more, preferably two, moieties containing six or more carbon atoms. Suitable cationic softening agents for use herein are disclosed, for example, in EP-A-1201 741. Other suitable softening agents are clay softening agents. Any suitable clay softening agents may be used but preferred are those which comprise a clay mineral compound and optionally a clay flocculating agent. The clay mineral compounds are preferably smectite clay compounds, as those disclosed in US-A-3,862,058, U.S. Pat. No. 3,948,790, U.S. Pat. No. 3,954,632 and U.S. Pat. No. 4,062,647.

Another type of softening agents that may be included in the compositions of the present invention includes silicone-based softening agents. Suitable silicone softening agents are preferably those based on polyorganosiloxanes, such as amino-substituted organopolysiloxane, epoxy-modified organopolysiloxane, and polydiorganosiloxane, as described in WO 02092666, EP-B-0422787 and U.S. Pat. No. 4,757,121.

Preferably the present cleaning compositions comprise from 0.1% to 40%, more preferably from 0.5% to 15% by weight of the total composition, of softening agents.

Organic Polymeric Compounds

The cleaning compositions of the present invention can comprise organic polymeric compounds. By organic polymeric compound it is meant essentially organic compound commonly found in detergent compositions having dispersant, anti-redeposition, soil release or other detergency properties. Organic polymeric compound is typically incorporated in the compositions of the invention at a level of from 0.01% to 30%, preferably from 0.05% to 15%, most preferably from 0.01% to 10% by weight of the compositions.

Examples of organic polymeric compounds include the water soluble organic homo- or co-polymeric polycarboxylic acids, modified polycarboxylates or their salts. Preferred are the copolymers of acrylic acid and maleic anhydride having a molecular weight of from 5000 to 10000, more preferably from 20000 to 100 000. Preferred commercially available acrylic acid containing copolymers having a molecular weight below 15000 include those sold under the tradename Sokalan PA30, PA20, PA15, PA10 and Sokalan CP10, CP5 by BASF Gmbh, and those sold under the tradename Acusol 45N, 480N, 460N by Rohm and Haas.

Other optional polymers may be polyvinyl alcohols and acetates both modified and non-modified, cellulosics and modified cellulosics, polyoxyethylenes, polyoxypropylenes, and copolymers thereof, both modified and non-modified, terephtalate esters of ethylene or propylene glycol or mixtures thereof with polyoxyalkylene units. Suitable examples are disclosed for example in U.S. Pat. No. 5,591,703, U.S. Pat. No. 5,597,789 and U.S. Pat. No. 4,490,271.

Wetting Agent

Wetting agents suitable for use herein are surfactants and include anionic, amphoteric, zwitterionic, non-ionic and semi-polar surfactants. Preferred non-ionic surfactants include silicone surfactants, such as Silwet copolymers, preferred Silwet copolymers include Silwet L-8610, Silwet L-8600, Silwet L-77, Silwet L-7657, Silwet L-7650, Silwet L-7607, Silwet L-7604, Silwet L-7600, Silwet L-7280 and mixtures thereof. Preferred for use herein is Silwet L-77.

Perfume

The perfume component of the present invention may comprise an encapsulate perfume, a properfume, neat perfume materials, and mixture thereof.

In the context of this specification, the term “perfume” means any odoriferous material which acts as a malodour counteractant. The perfume or deodorant materials employed herein will most often be liquid at ambient temperatures, but also can be solids such as the various tamphoraceous perfumes known in the art. A wide variety of chemicals are known for perfumery uses, including materials such as aldehydes, ketones, esters and the like. More commonly, naturally occurring plant and animal oils and exudates comprising complex mixtures of various chemical components are known for use as perfumes, and such materials can be used herein The perfumes herein can be relatively simple in their composition or can comprise highly sophisticated, complex mixtures of natural and synthetic chemical components, all chosen to provide any desired odour.

Tablet Coating

Preferably the cleaning compositions of the present invention are coated. The coating can improve the mechanical characteristics of a composition while maintaining or improving dissolution. The coating can also slow or stop the compositions from absorbing moisture.

Preferred coatings and methods for use herein are described in EP-A-846754. Particularly suitable coating ingredients are for example dicarbolylic acids such as those selected from oxalic acid, malonic acdi, succinic acid, glutaric acid, adipic acid, pimelic acid, suberic acid, azelaic acid, sebacic acid, undecanedioic acid and mixtures thereof. Most preferred is adipic acid.

Other suitable group of benefit agents which are preferably comprised in said secondary composition are optical brighteners, UV protection substances, dyes, silver protectants, perfumes and fragrances, fluorescers, active antimicrobial substances, wrinkle reducing agents, chelating agents, chloride scavengers, dyes, foam inhibitors, antiredeposition agents, graying inhibitors, dye transfer inhibitors, fabric abrasion reducing polymers, corrosion inhibitors, chelants/heavy metal ion sequestrants, crystal growth inhibitors, binders, disintegration aids, ironing auxiliaries, surface substantive modifying polymer, and mixtures thereof.

The secondary composition can also comprise some of the ingredients listed above for the primary composition.

Release Controlling Means

The cleaning compositions of the present invention further comprise at least one release controlling means capable of preventing said secondary composition to be released into the main wash liquor.

The expression “release controlling means” is intended to represent a means allowing to protect a composition from dissolution before the desired point in time and to deliver said composition at the desired moment during the cleaning operation. In particular, and as used in the present invention, the “release controlling means” represents a means enabling to prevent the secondary composition of the present cleaning composition from dissolving into the main wash cycle and to deliver said secondary composition into the rinse liquor.

The release controlling means typically comprises at least one component, which in reaction to changes in its immediate environment, for examples to changes of certain properties of the wash liquor, undergoes in its turn changes in its chemical or physical properties and by so, prevents or allows release of the secondary composition into the wash liquor.

The sequential delivery of different compositions in different cycles may then be achieved by including physical, chemical or mechanical controlled release-controlling means, depending on the particular component chosen for acting as controlling means. These latter can then be responsive to a change in one or more of pH, temperature, conductivity, pCa, pKa, redox potential, ionic concentration, enzymatic reaction or time.

In the context of the present invention, the cleaning composition comprises at least one release-controlling means comprising an amino-acetylated polysaccharide having a selected degree of acetylation.

According to a preferred embodiment of the present invention, said release-controlling means is pH-controlled and is therefore responsive to a change in the pH of the wash liquor. It is well known in the art that in the vast majority of the laundry and dishwashing machines currently available on the market, a pH shift of the wash liquor is typically observed between the main wash cycle and the rinse cycle, with alkaline detergent formulations due to the mere dilution. This pH shift, occurring independently of the temperature of the water, ranges from approximately 1 to 2 pH units.

Although the specific values of the pH shift are dependent on the amount of residual liquor remaining in the machine, it is considered that, in a typical laundry machine, the pH of the main wash liquor ranges approximately from 10 to 9, and from 9 to 8 in the rinse liquor. In the case of a dishwashing machine, the pH of the main wash liquor ranges approximately from 11 to 10, and from 10 to 9 in the rinse liquor.

According to the present invention, this one-unit shift of pH is exploited in order to effect the controlled release of benefit agents into the rinse liquor. In a preferred execution of the present invention, the pH-controlled releasing means is responsive to a pH shift of the wash liquor in the range from 11 to 7, preferably from 10 to 8.

In a particularly preferred embodiment, the cleaning composition of the present invention is provided with a pH-controlled releasing means comprising an amino-acetylated polysaccharide which, as a consequence of a change in the pH of the wash liquor in the range from 11 to 7, preferably from 10 to 8, undergoes a change in its solubility, and preferably exhibits an increased solubility in water.

While being intended to be used in a laundry washing machine, it is particularly preferred that the cleaning composition be provided with a pH-controlled releasing means which exhibit an increased solubility in the pH range of the wash liquor from 9 to 8. It is particularly preferred that said amino-acetylated polysaccharide comprised in said pH-controlled releasing means, has no or poor solubility at pH 10-9 (wash conditions) and has total or almost total solubility at pH 9-8 (rinse conditions).

When usage in a dishwashing machine is envisaged, it is particularly preferred that said amino-acetylated polysaccharide comprised in said pH-controlled releasing means, has no or poor solubility at pH 11-10 (wash conditions) and has total or almost total solubility at pH 10-9 (rinse conditions).

In order to exhibit a suitable solubility profile for use in the cleaning composition of the present invention, it has been surprisingly discovered that the degree of acetylation of said amino-acetylated polysaccharides must be carefully selected.

It has been unexpectedly discovered that when the degree of acteylation is comprised in the range from 30% to 80%, preferably from 45% to 75%, said amino-acetylated polysaccharide exhibits an extended solubility range versus pH, in comparison with commercially available compounds with a degree of acetylation typically below 25%. In particular, while commercial amino-acetylated polysaccharide having a degree of acetylation of 15%, are soluble only below a pH of 6.5, synthetic amino-acetylated polysaccharide having a degree of acetylation comprised between 45% and 55%, may be soluble in aqueous medium at pH values up to 8.5.

For use in a laundry washing machine, it is particularly preferred that said amino-acetylated polysaccharide comprised in said pH-controlled releasing means, has a degree of acetylation comprised between 30% and 80%, preferably between 40% and 60%, more preferably between 45% and 55%, and most preferably between 45% and 50%.

When the cleaning compositions of the present invention are used in a dishwashing machine, it is preferred that said amino-acetylated polysaccharide comprised in said pH-controlled releasing means exhibits a degree of acetylation comprised between 30% and 80%, preferably between 45% and 75%, more preferably between 55% and 75%, most preferably between 70% and 75%.

Furthermore, it has been still surprisingly discovered that a strong dependency exists between the average weight molecular weight of the amino-acetylated polysaccharide samples and the pH-sensitivity of the films made from them. In particular, the lower the average weight molecular weight, the higher the water solubility.

In a preferred embodiment of the present invention, the average weight molecular weight (M_{w}) of said amino-acetylated polysaccharide may be advantageously selected from 10,000 Da to 500,000 Da, preferably from 50,000 Da to 300,000 Da, more preferably from 100,000 Da to 200,000 Da, in order to achieve a suitable solubility profile versus pH.

Without wishing being bound by theory, it is thought that the high water solubility of the chitosan derivatives which have a degree of acetylation comprised between 30% and 80% and a low molecular weight, is attributed to the decrease of intermolecular interactions, such as van der Waals forces; the lower the molecular weight, the lower the intermolecular attraction forces.

In the context of the present invention, a highly preferred amino-acetylated polysaccharide is selected to be chitosan. The production of chitosan having a degree of acetylation comprised between 30% and 80% and of low molecular weight, may be conducted using two different synthesis ways, either by homogeneous acetylation of “fully” deacetylated chitosan, or by homogeneous deacetylation of chitin.

In a preferred embodiment of the present invention, the required acetylated chitosan are produced by controlled homogeneous re-acetylation of deacetylated chitosan.

Without being bound by theory, it is thought that homogeneous conditions lead preferably to a random distribution of the acetamido groups along the amino-acetylated polysaccharide polymeric chain, whereas heterogeneous conditions provide predominantly a blockwise distribution. In addition, it is believed that said random distribution impacts favourably for obtaining compounds with a suitable solubility profile.

In a highly preferred embodiment of the present invention, and for use in a laundry washing machine, it is preferred that said amino-acetylated polysaccharide has a degree of acetylation comprised between 45% and 55%, an average weight molecular weight comprised between 100,000 Da to 200,000 Da, and a random distribution of the acetamido groups along the polymeric chain.

In a very preferred embodiment of the present invention for use in a dishwashing machine, it is preferred that said amino-acetylated polysaccharide has a degree of acetylation comprised between 55% and 75%, an average weight molecular weight comprised between 100,000 Da to 200,000 Da, and a random distribution of the acetamido groups along the polymeric chain.

The release controlling means of the present invention, allows releasing the secondary composition at the very early stages of the rinse cycle, and it efficiently prevents the latter composition to be released into the main wash cycle.

In another embodiment of the present invention, the release controlling means may further comprise additional polymeric materials. Preferred polymers, copolymers or derivatives thereof suitable for use as polymeric material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

Mixtures of polymers can be beneficial to further control the mechanical and/or dissolution properties of the release controlling means, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different average weight molecular weights.

Most preferred polymeric materials are PVA having a average weight molecular weight, preferably from 1,000 Da to 1,000,000 Da, more preferably from 10,000 Da to 300,000 Da, and most preferably from 20,000 Da to 150,000 Da, such as those known under the trade reference Monosol M8630, as sold by Chris-Craft Industrial Products of Gary, Ind., US.

When such polymeric materials are further comprised in said release controlling means together with the amino-acetylated polysaccharide, it is preferred that the weight ratio of the polysaccharide to the additional polymeric material be from 0.1:100 to 50:100, preferably from 1:100 to 10:100.

According to the present invention, the release controlling means may be provided in the form of a film, a coating, an agglomerating material, a disintegrant or combinations thereof. In a preferred execution of the present invention, the release-controlling means is used in the form of a coating. Any conventional method for coating may be used in the context of the present invention.

In a preferred embodiment of the present invention, the secondary composition of the cleaning composition, may comprise one or more pH shift boosters. Those compounds are intended to increase the drop in pH of the wash liquor typically observed between the main wash cycle and the rinse cycle, and then help and accelerate the dissolution of the pH sensitive release controlling means into the rinse liquor. These compounds will, in particular, encourage the dissolution of the coating debris, when said release-controlling means is applied as a coating.

Suitable pH shift boosters may be selected from the group consisting of organo aminophosphonic acids and aminopolyphosphonic acids, organo phosphonic acids and polyphosphonic acids, polycarboxylic acids, polysulfonic acids, boric acids, alkylsulfuric acids, anhydrides of these acids, and mixture thereof. Polycarboxylic acids, such as for example citric acid, are particularly preferred for use in the cleaning compositions of the present invention.

In one embodiment, the pH shift boosters according to the present invention, may be incorporated into the secondary composition of the cleaning composition, in the case of which they will enter into action during the rinse cycle as soon as a breach has been formed onto said release-controlling means. In an alternative embodiment, the pH shift boosters may be included into the primary composition of the present cleaning composition. In this latter case, the suitable compounds may be provided in such a way that they evolve their function either after the end of the main wash cycle, or at the beginning of the afterwash cycle or rinse cycle. This controlled delivery of the pH shift boosters may be achieved for example, by coating them with a slow-dissolving coating material.

In still a further preferred embodiment of the present invention, said secondary composition may comprise degrading enzymes. Those enzymes are intended to degrade portions of the release controlling means that could possibly remain into the rinse liquor. However, this particular embodiment is suitable only when it is not intended to take profit of the benefits provided by the amino-acetylated polysaccharide comprised into said release-controlling means.

Appropriate degrading enzymes may be selected from chitosanase, chitinase, papain, cellulase, hemicellulase, pectinase, lipase, lysosyme, or other hydrolysing enzymes. Chitosanase and chitinase, or mixtures thereof, are of particular interest.

Alternative Designs of the Cleaning Compositions

According to a preferred execution of the present invention, the secondary functional part is enclosed within the primary functional part. In this latter embodiment, a particularly advantageous configuration of the present cleaning composition consists in a tablet provided with at least one cavity formed within said primary functional part, said cavity being at least partially filled up with said secondary functional part in the form of at least one particle.

Preferably, the tablets according to the present invention may adopt any suitable shape selected from the group consisting of hexagonal, square, rectangular, circular, oval, cylindrical and spherical.

In a preferred embodiment of the present invention, said at least one cavity is designed so as it does not extend entirely from the upper surface to the lower surface of said tablet but forms a depression. It is particularly preferred that said depression adopts a basal surface selected from hexagonal, square, rectangular, circular and oval. In one preferred execution, the particle or particles are preferably received in the cavity or depression in such a way that they do not project over the tablet surface. In still a further embodiment, the particle or particles are loosely arranged in the cavity or depression, in such a way that they cannot pass through the opening of said cavity or depression.

Alternatively, the cleaning composition of the present invention may be provided with at least one cavity centrally placed in the interior of the tablet in such a way that it is not visible from the outside.

In one preferred embodiment of the present invention, the cleaning composition is in the form of a tablet provided with at least one cavity formed within said primary functional part, said cavity containing said secondary functional part in the form of at least one particle, the external surface of said secondary functional part being entirely covered with a coating comprising said amino-acetylated polysaccharide. Although it is preferred that the external surface of each said particle be covered with said coating, it may also be envisaged to cover the external surface of an aggregate of said particles with said coating. In this latter case, the coating comprising said amino-acetylated polysaccharide would also help at binding said particles together in the form of an aggregate.

According to another preferred embodiment, the cleaning composition of the present invention may be in the form of a tablet provided with at least one cavity formed within said primary functional part, said cavity being at least partially filled up with said secondary functional part in the form of at least one particle, the inner surface of said cavity being completely surrounded with a coating comprising said amino-acetylated polysaccharide. According to this embodiment, said secondary functional part is completely encased within said coating.

In the particular case where the tablet is designed in such a way that said cavity or depression is visible from the outside, a portion of said coating will form a sort of lid which prevents said secondary functional part of being dispersed prematurely into the main wash liquor.

In still another preferred execution of the present invention, the primary functional part is in the form of a pouch, preferably a multi-compartment pouch, especially a powder liquid dual-compartment pouch, the secondary functional part is in the form of a compressed or compacted particulate body, preferably being inside the pouch, especially inside the powder compartment of the pouch, and the release controlling means is in the form of a coating on the surface of the compressed or compacted body. The compress body preferably has at least one dimension greater than about 1 cm, preferably greater than about 2 cm, in order to preclude the body from being flushed out of the washing machine after the main wash. In a very preferred embodiment, the coating comprises an amino-acetylated polysaccharide having a degree of acetylation of from 55% to 75%, an average weight molecular weight of from 80,000 Da to 140,000 Da, and the acetamido groups are randomly distributed along the polymeric chain.

According to a further preferred embodiment of the present invention, the secondary functional part is provided in the form of a plurality of discrete particles comprising benefit agents. This configuration helps to ensure the agents are more evenly distributed around the wash thus there is a more uniform application of the benefits to the fabrics or dishware/tableware.

In a preferred aspect of the present invention, the particles of the secondary functional part comprising benefit agents float in deionised water at 20° C. While not wishing to be bound theory, it is believed that having particles comprising benefit agents which may float will result in said particles remaining in the interior of the automatic machine during the wash cycle. For example, many benefits agents perform best when they are added during the rinse cycle. However, during the normal wash cycle, the wash liquor is pumped out of the machine at the end of the main wash cycle, and any particles that do not float are likely to be lost with the water. Also, floating particles reduce the risk of theses particles being caught up in the mechanism of the machine or in the fabrics/dishware, thus avoiding mechanical stresses that can cause premature release of the benefit agents.

Alternatively, the cleaning compositions of the present invention may also designed such that said primary functional part is in the form of at least one granule and said secondary functional part is in the form of at least one granule covered with a coating comprising said amino-acetylated polysaccharide.

Process

According to another aspect of the present invention, there is provided a process for making the cleaning compositions of the present invention, the process comprising the steps of a) preparing the secondary functional part comprising the secondary composition; b) coating the secondary functional part formed in step (a) with a film or coating comprising an amino-acetylated polysaccharide having a degree of actetylation comprised in the range from 30% to 80%; and c) preparing the primary functional part comprising the primary composition and enclosing the coated secondary functional part formed in step (b).

The cleaning compositions of the present invention may be prepared simply by mixing the solid ingredients together and compressing the mixture in a conventional tablet press as used, for example, in the pharmaceutical industry. Preferably the principal ingredients are used in particulate form. Any liquid ingredients can be incorporated in a conventional manner into solid particulate ingredients. Preferably the compositions of the present invention are compressed at a force of less than 10,000 N/cm², more preferably not more than 3,000 N/cm², even more preferably not more than 750 N/cm². Indeed, the more preferred embodiments of the present invention are compressed with a force of less than 500 N/cm². Generally, the compositions herein will be compressed with relatively low forces to enable them to disintegrate quickly.

The particulate material used for making the tablet of this invention can be made by any particulation or granulation process. An example of such a process is spray drying (in a co-current or counter current spray drying tower) which typically gives low bulk densities of 600 g/l or lower. Particulate materials of higher bulk density can be prepared by a continuous granulation and densification process. Other suitable processes include fluid bed processes, compaction processes (e.g. roll compaction), extrusion, as well as any particulate material made by any chemical process like flocculation, crystallisation sentering, etc.

The components of the particulate material may be mixed together by any conventional means. The cleaning compositions may be manufactured by using any compacting process such as tabletting, briquetting or extrusion, preferably tabletting. Suitable equipment includes a standard single stroke or a rotary press (such as is available from Courtoy®, Korsch®, Manesty® or Bonals®). Preferably the tablets are prepared by compression in a tablet press capable of preparing a tablet comprising a mould. The compositions herein preferably have a diameter of between 20 mm and 60 mm, preferably of at least 35 mm and up to 55 mm, and a weight of between 25 and 100 grams. In a preferred embodiment according to the present invention, the tablet has a density of at least 0.5 g/cc, more preferably at least 1.0 g/cc, and preferably less than 2.0 g/cc, more preferably less than 1.5 g/cc.

The secondary functional part may be coated using conventional procedures such as those known for tablet coatings. The amino-acetylated polysaccharide of the present invention can be sprayed onto the secondary functional part form a melt or form a solution or dispersion. In this case, the material to be coated is situated on a fluid bed ore in a tablet coating pan. The material to be coated may also be dispersed in a molten amino-acetylated polysaccharide in order then to be processed to form granulated material by spraying. For this purpose known spray-cooling, spray freezing or rotating disc procedures can be used. The amino-acetylated polysaccharide layer can be applied from an aqueous solvent or another solvent with the aid of spray-coating. The material to be coated is contained in this case in a tablet coating pan or on a fluid bed. It is also possible to disperse the material to be coated in the solution with amino-acetylated polysaccharide and then to spray-dry the dispersion. Alternatively, the amino-acetylated polysaccharide may be applied by coacervation technique.

When operating said coating, it may be suitable to incorporate plasticizers into the material to be coated. Preferred plasticizers for use herein include glycerol, ethylene glycol, polyethylene glycol, propylene glycol, polypropylene glycol, sorbitol, trialkyl citrate such as triethyl citrate, diethyl oxalate, diethyl succinate, dialkyl phtalate, dialkyl sebacate such as diethyl sebacate, triacetin, trialkyl phosphate such as triethyl phosphate, water, and mixtures thereof.

The process for making the cleaning compositions of the present invention typically comprises the additional step of inserting the coated secondary functional part into the mould comprised in the primary functional part, which may result in the mould being partially or totally filled with the coated secondary functional part. This latter may be alternatively compressed within the mould or adhesively bonded to the mould.

Pouches for use herein can be prepared according to methods known in the art. The method typically comprises preparing a film/sheet of the amino-acetylated polysaccharide of the present invention, cutting an appropriately sized piece of film/sheet, then folding the film/sheet to form the necessary number and size of compartments, and sealing the edges using any suitable technique such as heat-sealing or solvent-sealing. It may be suitable to incorporate plasticizers, as those listed above, when manufacturing pouches according to the present invention.

According to a further aspect of the present invention, there is provided a method of washing laundry in an automatic washing machine, said method comprising charging a washing machine with a cleaning composition according to the present invention and washing in a conventional manner. The method herein typically comprises treating soiled laundry with an aqueous solution in a washing machine having dissolved or dispensed therein an effective amount of a laundry machine detergent cleaning composition in accord with the invention.

In another embodiment, the present invention provides a method of washing cookware or tableware in an automatic dishwashing machine, said method comprising charging a dishwashing machine with a cleaning composition according to the present invention and washing in a conventional manner. The method herein typically comprises treating soiled cookware/tableware with an aqueous solution in a dishwashing machine having dissolved or dispensed therein an effective amount of a dishwashing machine detergent cleaning composition in accord with the invention.

Preferably, the cleaning compositions are dosed via the dispensing drawer of the machine but they can be added directly into the wash load. If added directly into the wash load, the cleaning compositions can be added as such or in combination with a dispensing device such as a reticulated bag or a pouch, such as those described in EP-A-0118678.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Test Methods

1. Degree of Acetylation

The degree of acetylation was determined by the method described by Y. Inoue, Chitin Handbook, R. A. A. Muzzarelli and M. G. Peter, eds; European Chitin Society, 1997; pg 133-136.

2. Molecular Weight

The molecular weight (average weight molecular weight M_{w}) determination was obtained according to that described by M. Terbojevich and A. Cosani, Chitin Handbook, R. A. A. Muzzarelli and M. G. Peter, eds; European Chitin Society, 1997; pg 97-101.

### EXAMPLES

### Example 1

### General Preparation of Half N-Acetylated Chitosan

Deacetylated chitosan (0.6 g) was dissolved in 10% aqueous acetic acid (100 mL), and acetic anhydride was added in excess. After stirring at ambient temperature for 5 hours, aqueous NaOH was added until the pH reached 8-9 in order to stop the reaction. The reaction mixture was dialyzed against deionized water for 2 days and lyophilized. The acetylated chitosan was then treated with methanolic KOH for 5-10 minutes at room temperature and repeatedly washed with methanol using a centrifuge. Finally it was dissolved in deionized water and lyophilized.

The degree of acetylation and the molecular weight were determined as described in the test methods, and the results listed in the table below. Alternatively, half N-acetylated chitosan could be obtained according to the report of Kurita K. et al. Chemistry Letters pp 1597-1598, 1989.

| | Average weight | Degree of |
|---|---|---|
| | molecular weight | acetylation |
| | (Mw) | (DA) |
| Chitosan A | 306 kDa | 40.4% |
| Chitosan B | 237 kDa | 43.7% |
| Chitosan C | 126 kDa | 47.0% |

### Example 2

### General Preparation of Films of Chitosan and Chitosan Derivatives

Chitosan films were obtained by evaporation of a solution of 5.0 g of a chitosan sample, prepared according to example 1, in 100 mL of 1% acetic acid. Thus, the solution was filtered through a 0.45 micrometer Millipore membrane, placed into 5 cm diameter Petri dishes, and air-dried for 24 hours at room temperature. After complete drying, films were easily recovered. Then, they were immersed in a solution of dilute ammonia in methanol (15 mL NH₄OH 33%/35 mL distilled water/500 mL methanol) to regenerate the free amino form of chitosan.

### Example 3

### General Preparation of Chitosan/PVA Films

PVA (20 g; Aldrich) was dissolved in cold deionised water (100 g) and then glycerol (7 g; Aldrich) added. A chitosan sample (2 g), prepared according to example 1, was dissolved in 1% acetic acid (100 g). The chitosan and PVA solutions were then mixed together and cast onto an A4 size plastic sheet to a thickness of 0.03 inches. The solution layer was dried at 40° C. for 2 hours and then removed from the sheet. To regenerate the free amino form of chitosan the films were immersed in a solution of dilute ammonia in methanol (15 ml NH₄OH 30%/35 ml deionised water/500 ml methanol) for 5 minutes.

### Example 4

### Detergent Cleaning Compositions

| | Cleaning | Cleaning | Cleaning |
|---|---|---|---|
| | composition | composition | composition |
| | A % by | B % by | C % by |
| | weight of | weight of | weight of |
| | total | total | total |
| | composition | composition | composition |
| Primary composition | | | |
| Anionic agglomerates 1 | 7.1 | — | — |
| Anionic agglomerates 2 | 17.5 | 33.0 | 33.0 |
| Nonionic agglomerates | 9.1 | 7.0 | 7.0 |
| Cationic agglomerates | 4.6 | — | — |
| Layered silicate | 9.7 | 7.7 | 7.7 |
| Sodium Percarbonate | 12.2 | 14.0 | 14.0 |
| Bleach activator agglomerates | 6.1 | 4.0 | 4.0 |
| Sodium carbonate | 5.5 | 4.0 | 4.0 |
| EDDS/sulphate particle | 0.5 | 0.4 | 0.4 |
| Tetrasodium salt of | 0.6 | 0.5 | 0.5 |
| hydroxyethane diphosphonic | | | |
| acid | | | |
| Fluorescer | 0.3 | 0.3 | 0.3 |
| Zinc Phthalocyanine | 0.03 | 0.03 | 0.03 |
| sulphonate encapsulate | | | |
| Soap powder | 1.2 | 1.2 | 1.2 |
| Suds suppresser | 2.5 | 2.5 | 2.5 |
| Citric acid/citrate | 4.5 | 4.5 | 4.5 |
| Lipase | 0.15 | 0.15 | 0.15 |
| Protease | 0.35 | 0.35 | 0.35 |
| Amylase | 0.2 | 0.2 | 0.2 |
| Cellulase | 0.01 | 0.01 | 0.01 |
| Sodium anhydrous acetate | 3.0 | 3.0 | 3.0 |
| Binder spray on system | 3.1 | 2.9 | 2.9 |
| Perfume spray-on | — | 0.4 | 0.4 |
| Miscellaneous | 4.3 | 3.7 | 3.7 |
| Secondary composition | | | |
| Perfume | 0.4 | — | — |
| Cationic softener active | 1.0 | 3.0 | 3.0 |
| Zeolite A | 2.0 | 2.5 | 2.5 |
| Nonionic surfactant | — | 1.0 | 1.0 |
| Carbonate | 0.5 | — | — |
| Citric acid | 0.5 | — | — |
| Chitosanase | — | — | 2 Units |
| Polyethylene glycol | 1.0 | 1.5 | 1.5 |
| Release controlling means | | | |
| Chitosan | 0.8 | 0.7 | 0.7 |
| Tablet Coating | | | |
| Adipic acid | 2 | 2 | 2 |
| Purolite ™ | 0.1 | 0.1 | 0.1 |

Anionic agglomerates 1 comprises 40% anionic surfactant, 27% Zeolite A and 33% Sodium carbonate
Anionic agglomerates 2 comprises 35% anionic surfactant, 26% Zeolite A, 28% Sodium carbonate, and 11% sodium acetate anhydrous.
Nonionic agglomerates comprise 26% non-ionic surfactant, 6% Lutensit K-HD 96, ex BASF, 40% sodium acetate anhydrous, 20% sodium carbonate and 8% zeolite.
Cationic agglomerate comprises 20% cationic surfactant, 56% zeolite and 24% sulfate.
Layered silicate comprises of 95% SKS-6 and 5% silicate.
Bleach activator agglomerates comprise 81% tetraacetylethylene diamine (TAED), 17% acrylic/maleic copolymer (acid form) and 2% water.
EDDS/Sulphate particle comprise 58% ethylene diamine N,N-disuccinic acid sodium salt, 23% of sulfate and 19% water.
Zinc phthalocyanine sulfonate encapsulates are 10% active.
Suds suppresser comprises 11.5% silicone oil (ex Dow Corning), 59% zeolite and 29.5% H₂O.
Binder spray-on system comprises 0.5 parts of Lutensit K-HD 96 and 2.5 parts of polyethylene glycol (PEG).
Chitosanase was purchased from Sigma Belgium (C0794).
Chitosan: degree of acetylation 46.9%, average weight molecular weight 232 kDa, obtained from Koyo Chemicals.
Purolite ™: available from Purolite International Ltd, Rhonda Cynon-Taff, UK
1 unit: one unit liberates 1 micromole of reducing sugar per minute at pH 5.5 at 37° C.

The detergent active primary composition was prepared by admixing the granular components in a mixing drum for 5 min to create a homogeneous particle mixture. During this mixing, the spray-on was carried out with a nozzle and hot air using the binder composition described above.

The particles forming the secondary functional part were manufactured using a Braun food processor with a standard stirrer where the dry mixture described above is added. The mixer was operated at high speed during 1 minute and the mix is poured into a Fuji Paudal Dome Gran DGL1 (Japan) extruder with 3 mm diameter holes in the extruder tip plate and operated at 70 revolutions per minute. The resulting product was added into a Fuji Paudal Marumerizer QJ-230 were it is operated at 1000 revolutions per minutes for 5 minutes were a good spheronization was achieved.

In a further step the particles were coated with N-acetylated chitosan. This was achieved by spraying the beads in a conventional mix drum with 4% (weight beads based) of a mixture of N-half acetylated chitosan and water at 80° C. using a spray nozzle and hot air. The secondary composition could also contain the enzyme prill Chitosanase (ex Novo). The resulting particles had a density of 700 kg/m³. The particle size was measured using the ASTM D502-89 method and the calculated average particle size was 2.6 mm.

A multiphase tablet composition was prepared using an Instron 4400 testing machine and a standard die for manual tablet manufacturing. 35 g of the detergent active primary composition was fed into the dye of 41×41 mm with rounded edges which has a ratio of 2.5 mm. The mix was compressed with a force of 1500 N with a punch that has a suitable shape to form a concave mould of 25 mm diameter and 10 mm depth in the tablet. The shaped punch was carefully removed leaving the tablet into the dye. 4 g of particles were introduced into the mould left in the primary composition and a final compression of 1700 N was applied to manufacture the multiphase tablet using a flat normal punch. The tablet is then manually ejected from the dye.

In a following step the tablet made with the process described above was coated by manually dipping them into a molten mixture of coating at 170° C. and let them cool back to room temperature allowing the coating to harden. The composition and percentage of the coating are described in the tablet composition above.

### Example 5

### Detergent Cleaning Composition

| | Cleaning composition D |
|---|---|
| | % by weight of |
| | total composition |
| Primary Powder composition | |
| Sodium Tripolyphosphate | 34.6 |
| Sodium silicate | 5.7 |
| Sodium carbonate | 21.6 |
| Polymer | 4.2 |
| Polytergent SLF 18 | 3.8 |
| Sodium Percarbonate | 12.1 |
| PCA/PEG co-flake | 0.6 |
| Amylase | 1.3 |
| Protease | 1.5 |
| Perfume | 0.2 |
| Primary Liquid composition | |
| Dipropylene glycol | 3.7 |
| Dye solution | 0.1 |
| Amine oxide | 0.7 |
| Polytergent SLF 18 | 4.5 |
| Secondary composition | |
| Citric acid | 2.0 |
| Silwet L77 | 0.2 |
| Silicone suds suppresser | 0.2 |
| Perfume | 0.05 |
| Dye | 0.05 |
| Release controlling means solution | |
| PVA | 2.9 |
| Chitosan | 0.05 |

PCA/PEG co-flake: Pentaamine cobalt (III) acetate dichloride/Polyethylene glycol co-flake.
PVA: Polyvinyl alcohol, average weight molecular weight 36 kDa, purchased from Sigma-Aldrich.
Chitosan: degree of acetylation 60%, average weight molecular weight 120 kDa.

A tablet is prepared by admixing the components of the secondary composition; the mixture is then passed into the die of a conventional rotary press. The die has a circular cross-section of 1.5 cm of diameter. The composition is then subjected to a compression force of 940 kg/cm², the punch is elevated, and tablet ejected from the tablet press. The tablet is coated by spraying on a solution having the composition specified in the above table, and then left to dry. Separately, a dual compartment PVA pouch (Monosol M8630 film as supplied by Chris-Craft Industrial Products) is formed and filled with the primary composition. The first compartment is filled with the powder composition and the coated tablet and the second compartment is filled with the liquid composition.

The pouch is introduced in the 25 ml dispenser compartment of a Bosch Siemens 6032 dishwashing machine, the dispenser is closed and the washing machine operated in its normal 55° C. program. The tablet is still undissolved after the main wash and fully dissolves after the rinse.

What is claimed is:

1. A cleaning composition, for use in an automatic laundry or dishwashing machine, said composition comprising at least two functional parts including a primary functional part, and a secondary functional part, wherein in use in an automatic laundry or dishwashing machine having a main-wash cycle and a rinse cycle, the primary functional part releases a primary composition into the main wash, and the secondary functional part releases a secondary composition into the rinse, said cleaning composition further comprising at least one release controlling means capable of preventing said secondary composition to be released into the main wash liquor, wherein said means comprises an amino-acetylated polysaccharide having a degree of actetylation of from about 30% to about 80%.

2. The cleaning composition of claim 1 wherein the amino-acetylated polysaccharide has a degree of actetylation of from about 45% to about 75%.

3. The cleaning composition of claim 1 wherein said amino-acetylated polysaccharide has an average weight molecular weight (Mw) from about 50,000 Da to about 300,000 Da.

4. The cleaning composition of claim 3 wherein said amino-acetylated polysaccharide has a random distribution of the acetyl groups along the polymeric chain.

5. The cleaning composition of claim 4 wherein said amino-acetylated polysaccharide is chitosan.

6. The cleaning composition of claim 1 wherein said release controlling means is responsive to a change in the pH of the wash liquor in the range from about 11 to about 7.

7. The cleaning composition of claim 1 wherein said primary composition is selected from the group consisting of detergent, bleaching agent, water softener, and mixtures thereof.

8. The cleaning composition of claim 1 wherein said secondary composition is selected from the group consisting of rinse aids, finishing agents, softeners, disinfectants, fragrances, dye transfer inhibiting agents, optical brighteners, anti-redeposition agents, corrosion inhibitors, silver protectants, soil repellents, antistatic agents, antimicrobial substances, ironing auxiliaries, and mixtures thereof.

9. The cleaning composition of claim 1 wherein said release controlling means further comprises at least one additional polymeric materials selected from the group consisting of polyvinyl alcohols, acrylic acid, polyvinyl acetates, polyvinyl alcohol copolymers, hydroxypropyl methyl celluloses (HPMC), and combinations thereof.

10. The cleaning composition of claim 1 wherein said secondary composition further comprises one or more pH shift booster selected from the group consisting of organo aminophosphonic acids and aminopolyphosphonic acids, organo phosphonic acids, polyphosphonic acids, carboxylic acids, polycarboxylic acids, polysulfonic acids, and mixtures thereof.

11. The cleaning composition of claim 1 wherein said release controlling means is in a form selected from the group consisting of pH sensitive films, coatings, agglomerating materials, and combinations thereof.

12. The cleaning composition of claim 1 wherein said primary and/or secondary functional part is or more of the following forms: pouch, capsule, tablet or granule, said release controlling means is in one or more of the following forms: film, coating, or agglomerating material, and said primary and/or secondary composition is in one or more of the following forms: free flowing powder, compressed powder, liquid, liquid-solid suspension, gel or paste.

13. The cleaning composition of claim 1 wherein said secondary functional part is enclosed within said primary functional part.

14. The cleaning composition of claim 13 wherein said cleaning composition is in the form of a tablet provided with at least one cavity formed within said primary functional part, said cavity containing said secondary functional part in the form of at least one particle, the external surface of said secondary functional part being entirely covered with a coating comprising said amino-acetylated polysaccharide.

15. The cleaning composition of claim 13 wherein said cleaning composition is in the form of a tablet provided with at least one cavity formed within said primary functional part, said cavity containing said secondary functional part in the form of at least one particle, the inner surface of said cavity being completely surrounded with a coating comprising said amino-acetylated polysaccharide.

16. The cleaning composition of claim 13 wherein said primary functional part is in the form of a single or multi-compartment pouch, the secondary functional part is in the form of a compressed or compacted body, and the release controlling means is in the form of film or coating on the surface of the compressed or compacted body.

17. The cleaning composition of claim 1 wherein said primary functional part is in the form of at least one granule and said secondary functional part is in the form of at least one granule covered with a film or coating comprising said amino-acetylated polysaccharide.

18. A process for making the composition of claim 1 comprising the steps of:
(a) preparing the secondary functional part comprising the secondary composition;
(b) coating the secondary functional part formed in step (a) with a film or coating comprising an amino-acetylated polysaccharide having a degree of actetylation of from about 30% to about 80%; and
(c) preparing the primary functional part comprising the primary composition and enclosing the coated secondary functional part formed in step (b) within said primary functional part.

19. A pH sensitive film or coating composition, for use in an automatic laundry or dishwashing machine, said composition comprising an amino-acetylated polysaccharide having a degree of actetylation of from about 30% to about 80%.

20. The pH sensitive film or coating composition of claim 19 further comprising at least one additional polymeric materials selected from the group consisting of polyvinyl alcohols, acrylic acid, polyvinyl acetates, polyvinyl alcohol copolymers, hydroxypropyl methyl celluloses (HPMC), and combinations thereof, and wherein the weight ratio of the polysaccharide to the additional polymeric material is from about 0.1:100 to about 50:100.
